(19) United States
(12) Patent Application Publication
(10) Pub. No.: US 2018/0367452 A1
(43) Pub. Date: Dec. 20, 2018

(54) INFORMATION CENTRIC NETWORKING OVER MULTI-ACCESS NETWORK INTERFACES

(71) Applicant: Futurewei Technologies, Inc., Plano, TX (US)

(72) Inventors: Syed Obaid Amin, Fremont, CA (US); Ravishankar Ravindran, San Ramon, CA (US)

(73) Assignee: Futurewei Technologies, Inc., Plano, TX (US)

(21) Appl. No.: 15/627,278

(22) Filed: Jun. 19, 2017

(51) Int. Cl. H04L 12/721; H04L 29/12

(52) U.S. Cl. CPC H04L 45/66; H04L 61/35; H04L 61/6022; H04L 61/20

(57) ABSTRACT

Technology for forwarding of packets in an information centric (ICN) local area network is disclosed. A method and apparatus allow for accessing data or services using an ICN name using a dynamic layer 2 address. The method and apparatus access an interest name identifying data available via the ICN and computing a dynamic layer 2 address derived from the interest name identifying the data. The method and apparatus then cause a transfer of the data associated with the interest name between a provider processing device and a consumer processing device responsive to an interest packet identifying the consumer processing device and the provider processing device using the dynamic layer 2 address.

### BACKGROUND

Traditionally, the architecture of the Internet makes use of the Transmission Control Protocol/Internet Protocol (TCP/IP) model to provide information between information requesters and information providers. Recently, information-centric networking (ICN) has been proposed. The term “ICN” can refer to either an information centric network or information centric networking, depending on the context. Examples of ICN include, but are not limited to, Named Data Networking (NDN), Content Centric Networking (CCN), Content Oriented Networking (CON), Data Oriented Networking (DON), and Content Based Networking (CBN). Unlike traditional host-centric networking, information is directly named in an ICN. Thus, ICN allows a client device to focus on the data needed, as opposed to referencing a specific location from which the data may be retrieved.

For example, in CCN, a client node may send an interest packet to the network when the client wants to access a piece of a content object. CCN routers in the network then forward the interest packet using the name of the interest for routing. Once the interest packet reaches a cache holding a match for the interest, a content packet (e.g., “data packet”) may be sent back. The content packet may retrace the path followed by the interest packet in the reverse direction to the client node which requested the content.

Network switches generally perform their linking function by bridging Ethernet frames between Ethernet segments by copying Ethernet frames from one switch port to another, based on the Media Access Control (MAC) addresses in Ethernet frames. The format for an Ethernet frame includes: a destination address, containing the address of the device to which the frame is being sent; a source address, containing the address of the device sending the frame; and various other fields, including the data field that carries the data being sent between devices. An Ethernet switch controls the transmission of frames between switch ports connected to Ethernet cables using the traffic forwarding rules based on address learning. Switches make traffic forwarding decisions based on the 48-bit MAC addresses used in LAN standards, including Ethernet.

### SUMMARY

The technology, briefly described, includes a computer implemented method in a consumer processing device for accessing data in an information centric network (ICN), including: computing, with one or more processors, a dynamic layer two address derived from an interest name identifying the data. The computer implemented method also includes reading, with the one or more processors, a data structure to determine an interface from a plurality of ICN interfaces in the consumer processing device, the interface mapped to the dynamic layer two address. The computer implemented method also includes issuing, by the one or more processors, an interest packet to the interface to request transfer of the data identified by the interest name. The computer implemented method also includes receiving, by the one or more processors, the data identified by the interest name.

In another embodiment, the computer implemented method may comprise computing a dynamic layer two address which includes: computing a hash value of the interest name; selecting a portion of a hash of the interest name as a selected portion of the layer two address; and prepending an identifier to the selected portion.

In another embodiment, the computer implemented method may comprise a method where the identifier includes any of a number of least significant bits of a hexadecimal layer two name.

In another embodiment, the computer implemented method may comprise a method where the portion of the hash includes any of a number of bits at an end of the hash value.

In another embodiment, the computer implemented method may comprise a method where the dynamic layer two address identifies a provider processing device supplying the data associated with the interest name, and where said receiving includes receiving data from the provider processing device in response to the interest packet.

In another embodiment, the computer implemented method may comprise a method which further includes, prior to reading the data structure, identifying the interface from a plurality of ICN interfaces, the interface communicating with the provider processing device, the identifying including issuing a layer two packet having a source address as a layer two consumer address and a destination address as the dynamic layer two address, and receiving a reply packet having the source address as the dynamic layer two address and the destination address as the source address; and writing the interface mapping between the dynamic layer two address and the interface to the data structure.

In another embodiment, the computer implemented method may comprise a method which further includes, prior to reading the data structure, identifying the interface from a plurality of ICN interfaces, the interface communicating with the provider processing device, the identifying including receiving a layer two broadcast packet from the provider processing device having a source address as the dynamic layer two address and a destination address as a broadcast address. The computer implemented method may also include writing the interface mapping between the dynamic layer two address and the interface to the data structure.

A further aspect of the technology includes an ICN data consumer device, including a plurality of network interfaces. The ICN data consumer device also includes a non-transitory memory storage including instructions, and one or more processors in communication with the memory storage and the interfaces. The one or more processors execute the instructions to: receive a request for data associated with an interest name; compute a dynamic layer two address for the interest name; determine an interface from the plurality of interfaces mapped to the dynamic layer two address by reading a data structure in the consumer processing device; record an interface of the plurality of interfaces associated with the dynamic layer two address; issue an interest packet to the dynamic layer two address via the interface; and receive the data associated with the interest name.

Another aspect includes an ICN data provider apparatus, including a plurality of interfaces. The ICN data provider apparatus also includes a non-transitory memory storage including instructions and data associated with an interest name. The apparatus also includes one or more processors in communication with the memory, where the one or more processors execute the instructions to: compute a dynamic layer two address for the data associated with the interest name; receive a request for the data associated with the interest name via a layer two packet having a destination address including the dynamic layer two address and having a source address associated with a consumer processing device; determine an interface from the plurality of interfaces for source address; record the interface associated with the source address in a data structure; and reply to the request by sending the data associated with the interest name via one or more layer two packets having a destination address including the source address via the interface.

This Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying FIGURES for which like references indicate like elements.

FIG. 1 illustrates a network environment to provide content as requested by different users in a local area ICN.

FIG. 2A is a flowchart illustrating an overall method performed on a consumer or requesting processing device to access a named resource in a local area ICN.

FIG. 2B is a flowchart illustrating an overall method performed on a provider or host processing device to provide a named resource in a local area ICN.

FIG. 3 is a flowchart illustrating a method of calculating a dynamic L2 address.

FIG. 4 depicts the mapping of an ICN name to a dynamic L2 address.

FIG. 5 is a depiction of the processes performed by various components in a local area ICN using the name resolution routing protocol technology disclosed herein.

FIG. 6 is a depiction of another embodiment of processes performed by various components in a local area ICN using the name resolution protocol technology disclosed herein.

FIG. 7 illustrates an NRP table used to store dynamic L2 address mapping to communication interfaces.

FIG. 8 is a block diagram of a processing device 800 that can be used to implement various embodiments of the consumer and provider processing devices.

FIG. 9 illustrates an alternative network environment to provide content as requested by different users in a local area ICN.

FIG. 10 is a flowchart illustrating an overall method performed by an ICN controller in FIG. 9 to provide access a named resource in a local area ICN.

### DETAILED DESCRIPTION

The disclosure relates to technology for ICN networking over MAC interfaces using layer 2 addresses. The packets include, but are not limited to, interest packets and/or data packets in an ICN. Note that herein the term “interest packet” will be understood to be a packet that seeks content in an ICN. Herein the term “data packet” will be understood to be a packet that returns content (e.g., a content object) in an ICN in response to a request for that content.

The technology uses a dynamic L2 address which is derived from an ICN name identifying data available in a local area ICN. The technology also uses the native L2 routing properties of switches used in such networking. In this instance, layer 2 or “L2” refers to the Data Link layer of the Open Systems Interconnection (OSI) seven-layer network model. Ethernet switches operate on local area network frames at the Data Link layer, and are often referred to as well as layer 2 devices or layer 2 switches

Each of content provider devices and content consumer devices connected to a local area ICN may derive and utilize a dynamic L2 address with a name resolution protocol (NRP) standardized on the derivation of the L2 address from the ICN name or interest name of content available on the local area ICN. This dynamic L2 address may be referred to herein as an NRP L2 address. Each of the content consumer and provider processing devices accessing the local area ICN include an NRP table and NRP controller, allowing the devices to map the dynamic L2 address to network interfaces in the local area ICN in order to route layer 2 packets between devices to access content associated with interest names.

One advantage of the present technology is that conventional layer 2 network switches upon which many networks are built need not be modified in order to implement a local area ICN. As such, the technology allows for the implementation of a local area ICN over conventional layer 2 routing hardware without modifying the hardware. The technology provides a single identifier which is associated with the ICN name of the service or data which the consumer is interested in receiving. This enables promiscuous mode of Ethernet communication between devices. Utilizing a prepended packet identifier, irrelevant packets are automatically filtered out by both network switches and endpoint devices. Resolved names are cached in local device data structures (referred to herein as NRP tables) for future use in accessing the content.

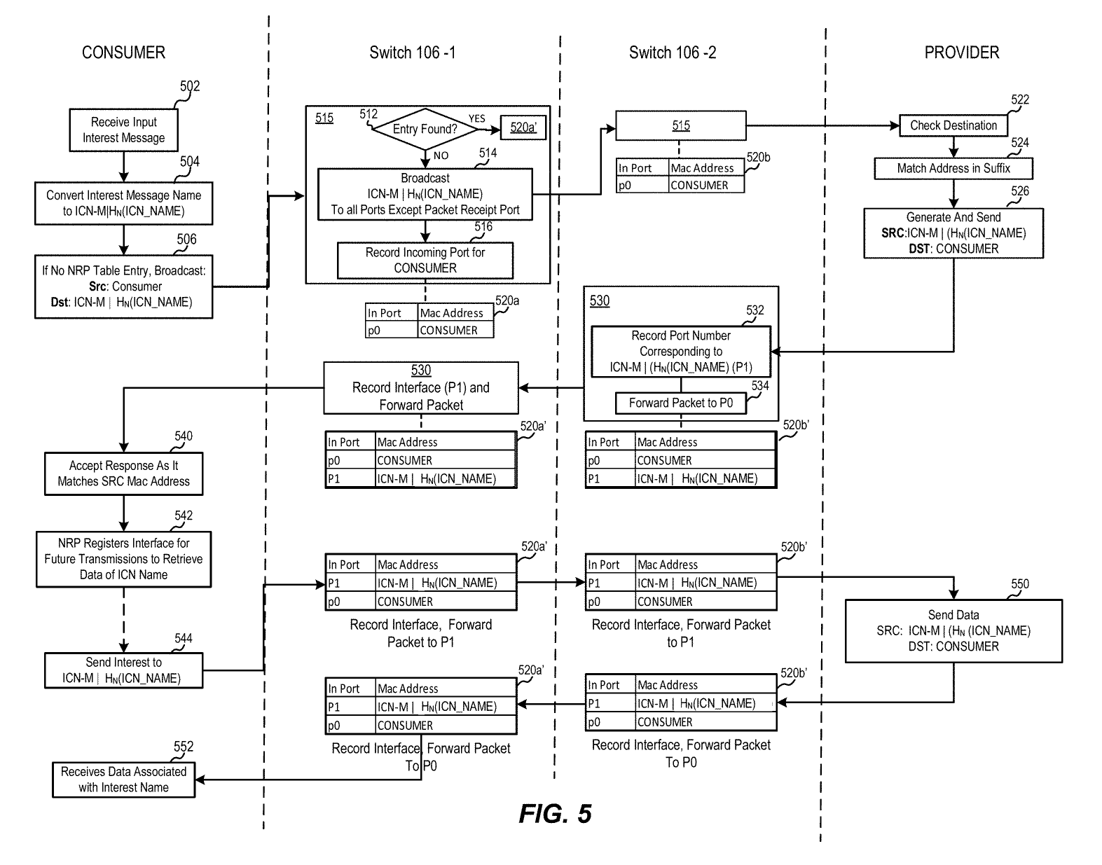

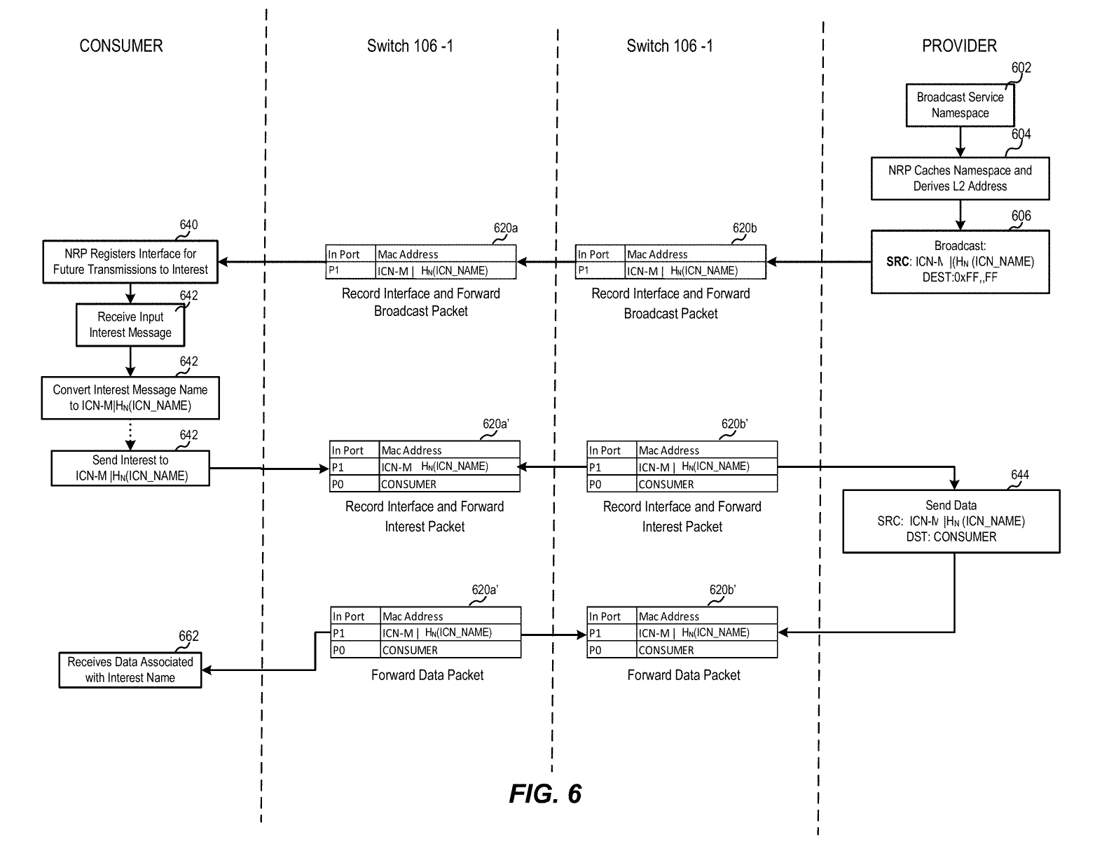

Two types of resolution are supported—consumer initiated resolution (discussed with respect to FIG. 5) and provider initiated resolution (discussed with respect to FIG. 6).

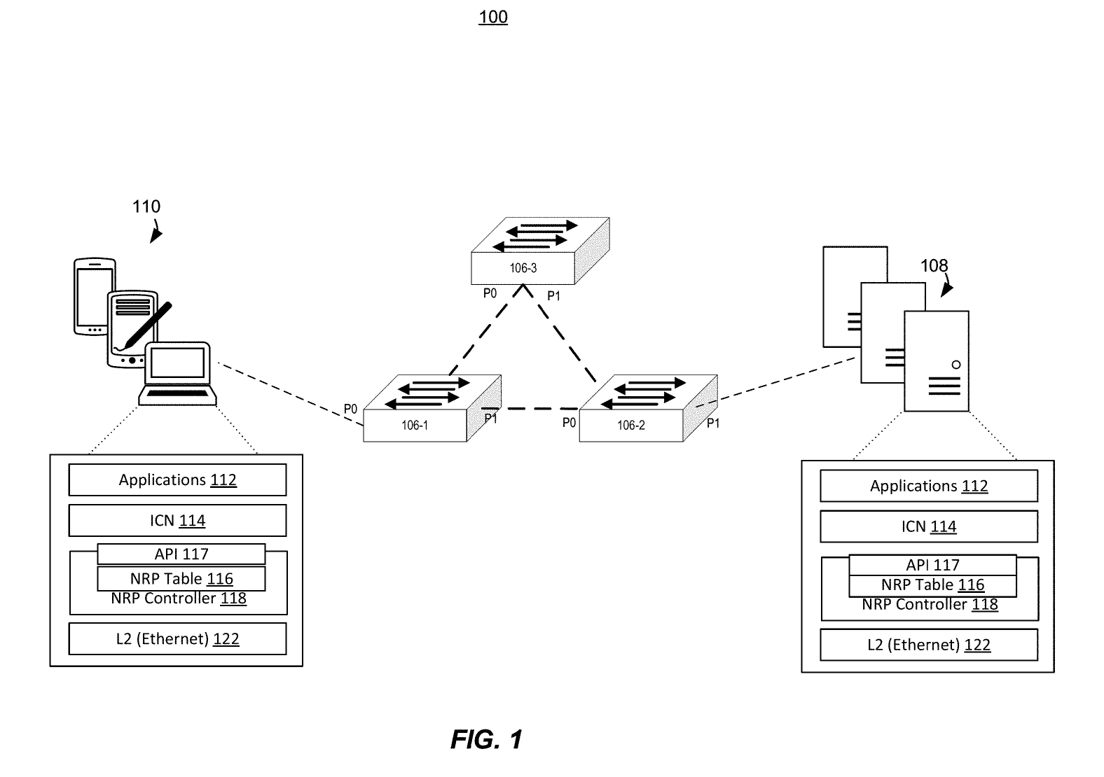

FIG. 1 illustrates a network environment 100 to provide content as requested by different users of an information centric network (ICN) running on an Ethernet based LAN. The ICN 102 may be, but is not limited to, a Named Data Network (NDN), Content Centric Network (CCN), Content Oriented Network (CON), Data Oriented Network (DON), or Content Based Network (CBN). In FIG. 1, the network environment includes consumer processing devices 110, network switches or routers 106 (of which three switches 106-1, 106-2 and 106-3 are illustrated) and provider processing devices 108.

In one embodiment, the ICN is compliant with a CCN protocol. A CCN protocol emphasizes content by making it directly addressable and routable. Endpoints communicate based on named data instead of IP addresses. CCN is characterized by the basic exchange of content request messages (called “Interests”) and content return messages (called “Content Objects”). The Interest message is used to request data by name. Specifically, an Interest message can identify a chunk of content to retrieve. Alternatively, an Interest message can provide a name prefix and other qualifications to restrict what data is acceptable from the collection named by the prefix. Herein, the term “interest packet” includes, but is not limited to an interest message. The Content Object is used to supply data. Herein, the term “data packet” includes, but is not limited to the message that returns a Content Object.

Communication using the CCN protocol is receiver-controlled. A consumer of data (such as one of processing devices 115) transmits an interest message over available connectivity (network 102) and any party receiving the message and having data that matches, or satisfies, the request (according to the specifications in the Interest Message) may transmit a matching Content Object message. Data is only transmitted in response to an Interest that matches the Data. An Interest message may be transmitted using broadcast or multicast facilities of the underlying transport in order to reach many potential sources of data with minimal bandwidth cost.

Network 100 may also include switches (or nodes) 106 which may be Ethernet switches forwarding requests and data by bridging Ethernet frames based on the Media Access Control (MAC) addresses in the Ethernet frames. Each node 106 performs packet processing may be used to forward interest and/or data packets.

In one aspect of the present technology, an ICN is built using standard switches which require no modification to support ICN protocol. Each switch channels incoming data from any of multiple input ports to the specific output port that will take the data toward its intended destination. On an Ethernet local area network (LAN), a switch determines from the device MAC address in each incoming message frame which output port to forward it to and out of. In the OSI communications model, a switch performs the Layer 2 or data-link layer function. The switch looks at each packet and determines from a MAC address which device the packet is intended for and switches it out toward that device.

In the present technology, the layer 2 address is a dynamic address derived from the ICN name, as discussed herein.

The network environment 100 may further include provider processing devices 108, which may store the content or collections of content, such as files, images, videos, and the like. Additionally, the network environment 100 may include one or more consumer processing devices 110, including for example and without limitation, desktop computers, hand-held devices, laptops or other portable computers, network computers, mobile phones, landline phones, and the like. Accordingly, the switch 106 may relay data from or forward data to the provider processing devices 108 and consumer processing devices 110 to provide the content to different users.

Both provider processing devices 108 and consumer processing devices 110 may have a processor, a memory (which may or may not be non-transitory), a transceiver, and network interfaces (not shown). In particular embodiments, some or all of the functionality described herein as being provided by the processing device may be provided by the processor in the processing device executing instructions stored on the memory.

Consumer processing devices 110 represent any suitable end user device which is capable of communicating via a local area network and may include a mobile wireless communication device, wireless transmit/receive unit (WTRU), mobile station, fixed or mobile subscriber unit, pager, cellular telephone, personal digital assistant (PDA), smartphone, laptop, computer, touchpad, or consumer electronics device.

The information centric network 102 may include the hardware and software that provides an information centric network. In one embodiment, the information centric network 102 provides a wireless network. The information centric network 102 may include one or more computer systems.

Although FIG. 1 illustrates one example of a communication system, various changes may be made to FIG. 1. For example, the network environment 100 could include any number of processing devices 108, 110, nodes 106, or other components in any suitable configuration.

Each of provider processing devices 108 and consumer processing devices 110 may include applications 112, an ICN manager 114, a name resolution protocol (NRP) controller 118, and NRP table 116, and network or Ethernet controller 122. The NRP controller exposes an Application Programming Interface (API) 117 to the ICN manager 114 allowing the NRP controller, for example, to publish prefixes at the producer processing device. It should be recognized that there may be differences between the applications 112 present on consumer processing devices 110 and provider processing devices 108. Nevertheless, the functions of each of the components represented in the respective devices is similar. Applications 112 may be any type of applications which request or provide a resource using an information request. Applications 112 interact with the ICN manager 114 on the processing devices to communicate the interest request to the local area ICN 102. The network or Ethernet controller 122 allows the processing device to communicate with the local area ICN 102 as discussed herein.

The NRP controller 118 and NRP table 116 enable the technology discussed herein for name resolution protocol based on ICN names in an interest message. The NRP controller 118 takes an ICN resource name and maps the resource name to a dynamic L2 network layer address, with the NRP L2 address including a specific prefix identifier (referred to herein as ICN-M) allowing the address to be processed by the NRP controller of any consumer processing device 110 or provider processing device 108. The NRP L2 address produced also allows the switches 106 to forward the frames between the switches based on the NRP L2 address to the appropriate processing device in order to allow content objects to be retrieved based on an ICN name as discussed herein.

In the present technology, conventional Ethernet switches may be utilized without modification. Each requesting entity (consumer) and providing entity (provider) maintains an NRP table 116 and uses an NRP controller 118 to map ICN content names to L2 addresses, and routes requests and data for content using these L2 addresses maintained in the switch.

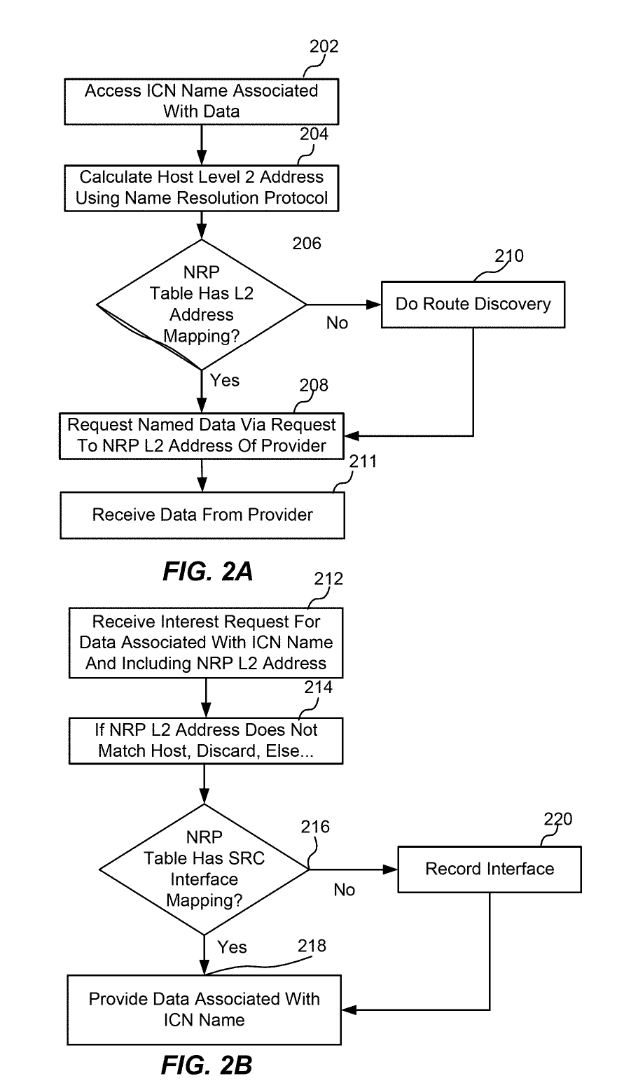

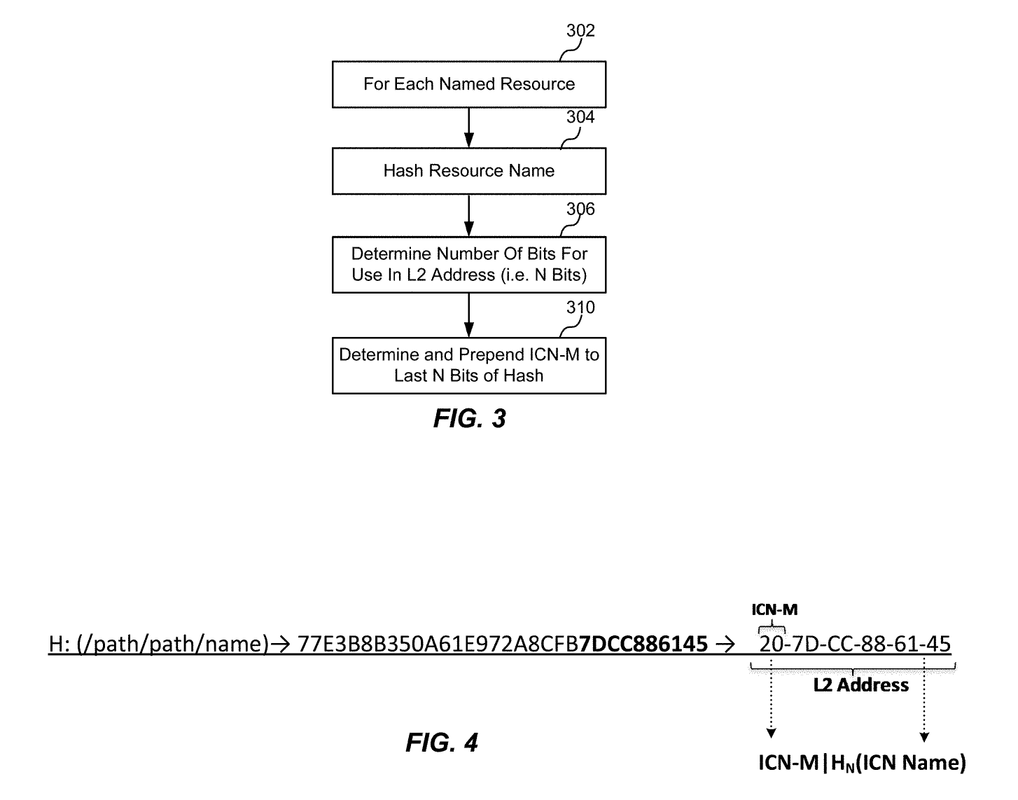

FIG. 2A illustrates a process performed by a consumer processing device when an application requests data using an ICN name. At 202, the ICN manager 114 accesses an ICN name associated with data. This access can be receiving a request from application to retrieve the data associated with the named resource. At 204, the NRP L2 address associated with the ICN name is calculated. A method for calculating the NRP L2 address using name resolution protocol is illustrated in FIG. 3. At 206, the NRP controller 118 determines whether in the L2 address has an associated (mapped) interface in the NRP table 116. If so, the consumer processing device 110 can request the data associated with the ICN name via the interface at 208. If not, then an interface discovery process 210 illustrated in FIG. 5 may occur. If the device 110 requests data via the interface at 208, it may then receive data from the provider at 211.

FIG. 2B illustrates a process performed by a provider processing device when it receives an interest request from a consumer device. The NRP table of a provider stores an address/interface association for processing devices requesting data based on ICN names which have been mapped to the NRP L2 address. At 212, a provider processing device may receive an interest request for data associated with an ICN name and including an NRP L2 address. An initial determination is made at 214 as to whether not the NRP L2 address matches the provider processing device. If it does not, the packet is discarded. If the NRP L2 address matches that provider processing device, then a check is made at 216 as to whether or not the NRP table has a source interface mapping recorded for the particular consumer processing device making the request. If no interface mapping is present for the consumer in the NRP table at 216, then the interface and source device address are recorded, then data associated with the ICN name can be provided at 218. If a consumer/source interface mapping is present at 216, then data associated with the ICN name can be provided at 218.

FIG. 3 illustrates a process to derive a L2 address from an ICN name. In one embodiment, FIG. 3 represents one method of performing step 204. At 302, for each named resource, at 304 for a hash of the named resource is performed. A hash of the resource ICN name is illustrated in FIG. 4. The hash results in a fixed length string representing the ICN name (in this example/path/path/name) which has some length dependent upon the hash function used. FIG. 4 illustrates a hash performed using an MD5 hash. At 206, some number (N) of bits for use in the L2 address is determined. In one embodiment, 40 bits are used, although other numbers of bits may be utilized. In one embodiment, any number for N may be utilized so long as N is standardized amongst all consumer and provider devices. In the example shown in FIG. 4, the last 40 bits of the hash are utilized as all but the least significant bits of an L2 address. At 310, an indicator, denoted herein as ICN-M, is used as a prefix to indicate that the Ethernet packet carries an ICN packet. In this example, ICN-M is indicated to be “20”, but can be any hexadecimal indicator. This allows ICN-M to be standardized to represent a multicast family that can be used solely for ICN flows, so that only ICN endpoint process these packets.

As illustrated in FIG. 4, the NRP L2 address can be denoted herein as ICN-M|H_{N}(ICN Name), where ICN-M is an indicator that the packet is an NRP, ICN packet, and H_{N} (ICN Name) indicates the last N bits of the hash function of the named resource.

FIG. 5 is a depiction of the processes performed by various components in a local area ICN using the NRP technology disclosed herein. FIG. 5 illustrates respective steps being performed on a consumer processing device (designated “consumer”), two switches 106-1 and 106-2 in the local area ICN 102, and a provider processing device (designated “provider”). At 502, a consumer processing device will receive an input interest message containing an ICN name of a resource. The input interest message at 502 can come from application, a user manipulating application, or some other source. At 504, the interest message ICN name is converted to the NRP L2 address having the format ICN-M|H_{N}(ICN Name) 506, if no NRP table entry exists before the L2 address, a packet containing the address is broadcast to the local area ICN 102. The packet will have identification of the source as consumer processing device with the destination identified by the NRP L2 address.

At 515, a first switch 106-1 will receive the broadcast packet at an incoming port (for example, port P0 of the switch 106-1) and make an initial determination at 512 as to whether or not the switch has an entry in its mac address table for the interfaces related to either the consumer processing device or the provider processing device associated with the ICN-M|H_{N}(ICN Name) address. If an entry is found, then the table will resemble table 520a′ (discussed below) wherein the switch 106-1 has interface entries for both the consumer and the provider processing device.

If no entries found at 512, then the switch 106-1 broadcasts the packet to all of its interface ports with the exception the inbound port on which it received the packet at 514. The switch also records the incoming port for the consumer at 516 resulting in a mac address table entry as illustrated at 520a. Following the broadcast of the interest packet, each switch in the local area ICN 120, will perform a similar process step 515 at that switch. For example, FIG. 5 illustrates one additional switch, switch 106-2, which likewise performs step 515 and records the inbound port of the interest packet in its own entry table, illustrated at 520b. This continues for all switches in the network until the packet reaches the provider processing device. Upon receipt at the provider processing device at step 522, the destination address (ICN-M|H_{N}(ICN Name)) is checked and a determination made at 524 as to whether or not the address matches the provider processing device address hosting the data associated with the ICN name. If no match occurs at 524, the packet is discarded.

If a match occurs at 524, the provider processing device generates and sends a return packet at 526 identifying itself as the source and the destination as the consumer processing device. This packet will follow the return path from switch 106-2 and switch 106-1. At switch 106-2, upon receipt at step 530, switch 106-2 will record the incoming interface port number corresponding to ICN-M|H_{N}(ICN Name) (in this example port P1) and for the packet of the incoming port (in this example port P0) which was identified and associated with consumer processing device. As result, the mac address table of switch 106-2 will appear as shown in table 520b′, and step 530 will be repeated at switch 106-1 resulting in mac address table 520a′. As a result, each of the switches is now knows which interfaces can be used to route L2 traffic between the consumer and provider processing devices such that when a data request is made by the consumer processing device for the data associated with the ICN name, each switch can route the information request packet and the return data packets between the consumer and the provider.

When the return packet reaches the consumer processing device at 540, the consumer processing device will accept the packet since destination address in the packet matches the consumer MAC address at 540, and at 542, will register the interface of it used to receive the packet for future transmissions of the interest packet to the provider processing device at ICN-M|H_{N}(ICN Name) in the consumer processing device's NRP table.

Later if a consumer wants to send an interest to the same producer, it will find the interface in the NRP at 544, and interest packet may be sent to the provider processing device via switch 106-1 and 106-2, each of which has in their internal address tables the correct interfaces to which to send the packet to quickly route the packet to the consumer. Upon receipt, at 550, the provider processing device since data in a data packet to the consumer via the return path in the consumer receives the data at 552.

FIG. 6 is a depiction of another embodiment of processes performed by various components in a local area ICN using the NRP technology disclosed herein. FIG. 6 illustrates an alternative method wherein the provider processing device may broadcast the availability of the data associated with the ICN name to devices on the local area network local area ICN 102.

At 602, a provider processing device broadcasts its service namespace. In one embodiment, the namespace is unbounded. At 604, the NRP table caches the namespace and derives the NRP L2 address for the name associated with the data. Derivation of the NRP L2 address in this instance may be performed in accordance with the methods disclosed in FIGS. 3 and 4 above. At 606, the provider NRP controller broadcasts the availability of the named resource using a broadcast packet (addressed to destination 0xFF-FF-FF-FF-FF-FF), identifying itself as the source of the NRP L2 address ICN-M|H_{N}(ICN Name).

When the broadcast packet is received by switches 106, each switch will record the interface ports on which the packet arrived. In the example shown in FIG. 6, switch 106-2 creates an entry in its mac address table 602b for port P0 and switch 106-1 creates an entry in table 602a. All other switches in local area ICN 102 will likewise create a mac address table entry. When the provider broadcast packet is received at the consumer processing device at 640, the NRP controller registers the interface on which the packet is received in the mac address table for further transmissions of interest packets of the named resource to the NRP L2 address.

When an request for the named resource is received by the consumer processing device (from, for example, an application on the consumer processing device) at 642, the ICN Name in the interest is converted to the NRP L2 address (ICN-M|H_{N}(ICN Name)).

An interest packet can then be forwarded to the provider using the NRP L2 address at 642. As the packet is processed by switches 106, each switch will forward the packet to the interface port on which the broadcast packet was received and record the interface used to communicate with the consumer processing device in their respective mac address tables 620a′ and 620b′.

Upon receipt of the interest packet by the provider, at 644, the provider processing device will record the interface used to communicate with the consumer processing device in its NRP table and forward data corresponding to the ICN Name for which the request was made back to the consumer, with the switches 106-1 and 1-6-2 using their address tables to forward the data packet. At 662, the consumer processing device will receive the packet and the process ends when all data has been received by the consumer.

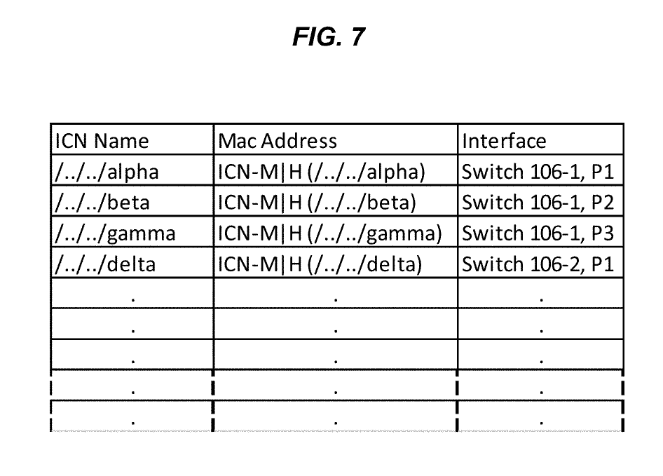

FIG. 7 illustrates an NRP table. Three columns and four example rows are illustrated. Each row contains one entry including the ICN Name of the resource, the NRP L2 address derived for the resource and the interface used to communicate with the resource. It will be understood that while three columns of data are associated with each entry, additional data may be stored for each entry. Other data structures may be utilized to store NRP data as alternatives to the NRP table.

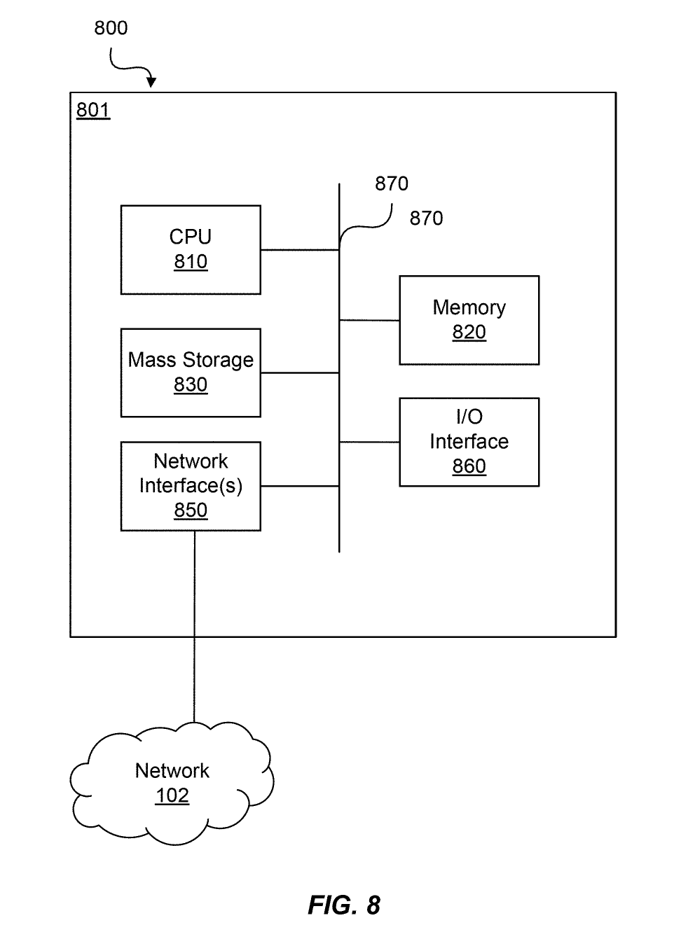

FIG. 8 is a block diagram of a processing device 800 that can be used to implement various embodiments of the consumer and provider processing devices. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system may comprise a processing unit 801 equipped with one or more input/output devices, such as network interfaces, storage interfaces, and the like. Each processing device may include multiple processing units. Each processing unit 801 may include a central processing unit (CPU) 810, a memory 820, a mass storage device 830, and an I/O interface 860 connected to a bus. The bus may be one or more of any type of several bus architectures including a memory bus or memory controller, a peripheral bus or the like.

The CPU 810 may comprise any type of electronic data processor. The CPU 810 may be configured to implement any of the schemes described herein, such as the processes illustrated in FIGS. 2, 3, 5 and 6 using any one or combination of steps described in the embodiments. The memory 820 may comprise any type of system memory such as static random access memory (SRAM), dynamic random access memory (DRAM), synchronous DRAM (SDRAM), read-only memory (ROM), a combination thereof, or the like. In an embodiment, the memory 820 may include ROM for use at boot-up, and DRAM for program and data storage for use while executing programs. In embodiments, the memory 820 is non-transitory. The mass storage device 830 may comprise any type of storage device configured to store data, programs, and other information and to make the data, programs, and other information accessible via the bus. The mass storage device 830 may comprise, for example, one or more of a solid state drive, hard disk drive, a magnetic disk drive, an optical disk drive, or the like.

The processing unit 801 also includes one or more network interfaces 850, which may comprise wired links, such as an Ethernet cable or the like, and/or wireless links to access nodes or one or more networks 880. The network interface 850 allows the processing unit 801 to communicate with remote units via the network 880. For example, the network interface 850 may provide wireless communication via one or more transmitters/transmit antennas and one or more receivers/receive antennas. In an embodiment, the processing unit 801 is coupled to a local-area network or a wide-area network for data processing and communications with remote devices, such as other processing units, the Internet, remote storage facilities, or the like. In one embodiment, the network interface 850 may be used to receive and/or transmit interest packets and/or data packets in an ICN. Herein, the term “port” will be understood to include a network interface.

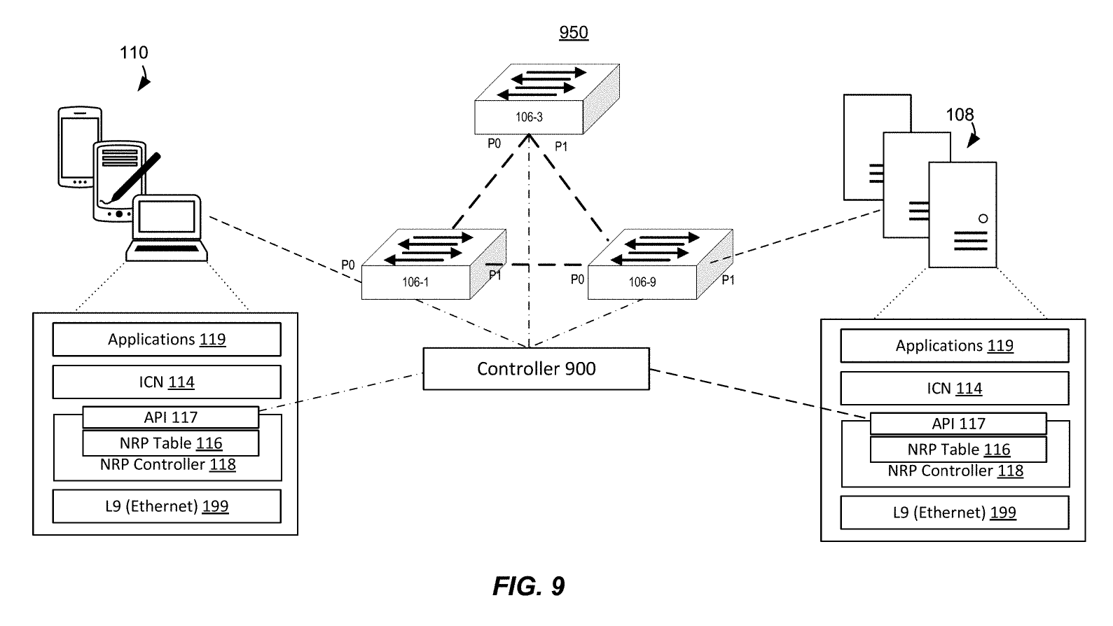

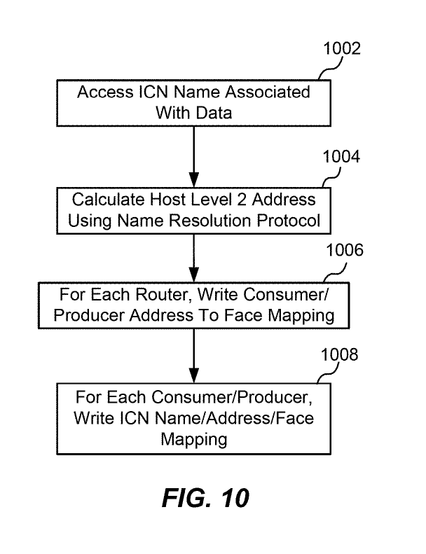

FIG. 9 illustrates an alternative configuration for a local area ICN 950. All elements illustrated in FIG. 9 which have reference numerals the same as those in FIG. 1 are equivalent to those in local area ICN 100 of FIG. 1. In local area ICN 950, a central ICN controller 900 populates the state of the NRP table and the Ethernet switches, using the NRP controller API 117. The ICN controller 900 may utilize either a centralized or distributed control plane. The ICN controller 900 may be one or more processing devices as described herein which implements code to instruct the ICN controller to perform the functions described below in FIG. 10.

FIG. 10 is a flowchart illustrating an overall method performed by the ICN controller 900 in FIG. 9 to provide access a named resource in a local area ICN. As illustrated in FIG. 10, at 1002, the ICN controller 1000 accesses the interest name which may be expressed by a consumer 110 or provided by a producer 108. At 1004, the NRP L2 address associated with the ICN name is calculated in the manner illustrated in FIG. 3. At 1006, for each router 106 in a path between consumer and producer, the controller writes the consumer/producer address to face mapping which will define a route between the devices. At 1008, using the API of the NRP controller the ICN controller writes the ICN Name to address and face mapping in each NRP table of the consumer and producer. The method of FIG. 10 may be performed upon expression of an interest by a consumer, upon the provider publishing the service on an ICN name.

Although the technology has been described with respect to the use of conventional Ethernet switches, it should be recognized that switches may be modified to include NRP tables in conjunction with its mac address tables. The L2 layer supports any number of ICN hosts, each containing many provider processing devices. At each host, the Ethernet layer can be modified to register the ICN-M|H(Name) addresses to a Bloom filter, so that ICN multicast requests can be filtered to a large extent. Name aggregation in the ICN layer can be uses to generate the ICN-M|H(Name). For contents under the prefix/a/b/c . . . , only first ‘N’ components can be used to generate the hash name (as illustrated in FIG. 4. In such case, both consumer and provider has to sync on the value of N.

Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment. Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method in a consumer processing device for accessing data in an information centric network (ICN), comprising:
computing, with one or more processors, a dynamic layer two address derived from an interest name identifying the data;
reading, with the one or more processors, a data structure to determine an interface from a plurality of ICN interfaces in the consumer processing device, the interface mapped to the dynamic layer two address;
issuing, by the one or more processors, an interest packet to the interface to request transfer of the data identified by the interest name; and
receiving, by the one or more processors, the data identified by the interest name.

2. The computer implemented method of claim 1 wherein computing a dynamic layer two address comprises:
computing a hash value of the interest name,
selecting a portion of a hash of the interest name as a selected portion of the layer two address, and
prepending an identifier to the selected portion.

3. The computer implemented method of claim 2 wherein the identifier comprises any of a number of least significant bits of a hexadecimal layer two name.

4. The computer implemented method of claim 2 wherein the portion of the hash comprises any of a number of bits at an end of the hash value.

5. The computer implemented method of claim 2 wherein the dynamic layer two address identifies a provider processing device supplying the data associated with the interest name, and wherein said receiving comprises receiving data from the provider processing device in response to the interest packet.

6. The computer implemented method of claim 5 wherein the method further includes, prior to reading,
identifying the interface from a plurality of ICN interfaces, the interface communicating with the provider processing device, the identifying comprising
issuing a layer two packet having a source address as a layer two consumer address and a destination address as the dynamic layer two address, and
receiving a reply packet having the source address as the dynamic layer two address and the destination address as the source address; and
writing the interface mapping between the dynamic layer two address and the interface to the data structure.

7. The computer implemented method of claim 5 wherein the method further includes, prior to reading,
identifying the interface from a plurality of ICN interfaces, the interface communicating with the provider processing device, the identifying comprising receiving a layer two broadcast packet from the provider processing device having a source address as the dynamic layer two address and a destination address as a broadcast address; and
writing the interface mapping between the dynamic layer two address and the interface to the data structure.

8. An ICN data consumer device, comprising:
a plurality of network interfaces;
a non-transitory memory storage comprising instructions; and
one or more processors in communication with the memory storage and the interfaces, wherein the one or more processors execute the instructions to:
receive (202) a request for data associated with an interest name;
compute a dynamic layer two address for the interest name;
determine an interface from the plurality of interfaces mapped to the dynamic layer two address by reading a data structure in the consumer processing device;
record an interface of the plurality of interfaces associated with the dynamic layer two address;
issue an interest packet to the dynamic layer two address via the interface; and
receive the data associated with the interest name.

9. The apparatus of claim 8 wherein the one or more processors execute the instructions to compute the dynamic layer two address by calculating a hash value of the interest name, select portion of a hash of the interest name as a portion of the layer two address, and prepend an identifier to the selected portion, the identifier indicating the layer two address is a dynamic layer two address.

10. The apparatus of claim 9 wherein the identifier comprises least significant bits of a hexadecimal layer two name and the portion of the hash comprises any of a number of bits at an end of the hash value.

11. The apparatus of claim 10 wherein the one or more processors execute the instructions to determine the interface from the plurality of interfaces by prior to the reading of the data structure, issuing a layer two packet to the dynamic layer two address, and receiving a layer two reply packet from a data provider apparatus identified by the dynamic layer two address;

12. The apparatus of claim 11 wherein the one or more processors execute the instructions to record the interface in a data structure comprising at least one entry associated with each interest name having mapped thereto a dynamic layer two address and the interface.

13. An ICN data provider apparatus, comprising:
a plurality of interfaces;
a non-transitory memory storage comprising instructions and data associated with an interest name; and
one or more processors in communication with the memory, wherein the one or more processors execute the instructions to:
compute a dynamic layer two address for the data associated with the interest name;
receive a request for the data associated with the interest name via a layer two packet having a destination address comprising the dynamic layer two address and having a source address associated with a consumer processing device;
determine an interface from the plurality of interfaces for source address;
record the interface associated with the source address in a data structure; and
reply to the request by sending the data associated with the interest name via one or more layer two packets having a destination address comprising the source address via the interface.

14. The apparatus of claim 13 wherein the one or more processors execute the instructions to compute the dynamic layer two address by calculating a hash value of the interest name, selecting a portion of a hash of the interest name as a selected portion of the layer two address, and prepending an identifier to the selected portion.

15. The apparatus of claim 14 wherein the identifier comprises any of a number of least significant bits of a hexadecimal layer two name and the portion of the hash comprises any of a number of bits at an end of the hash value.

16. The apparatus of claim 15 wherein the one or more processors execute instructions to receive the request for data by an interest packet from a consumer processing device, the packet having a destination address as the dynamic layer two address and being received via an interface mapped to a layer two source address of the consumer processing device, and outputting data to the source address associated with the consumer processing device in response to the interest packet via the interface.

17. The apparatus of claim 13 wherein the one or more processors execute instructions to broadcast a layer two broadcast packet having the source address as the dynamic layer two address and a destination address as a broadcast address.

18. The apparatus of claim 13 wherein the one or more processors execute instructions to write the interface mapping between the consumer processing device and the interface on which the request is received to a data structure, the data structure comprising at least one entry associated with each interest name having mapped thereto a dynamic layer two address and a switch interface.

19. The apparatus of claim 13 wherein the one or more processors execute instructions to
receive a broadcast packet from a consumer processing device having a source address of the consumer processing device and a destination address of the dynamic layer two address; and
read, with the one or more processors, a data structure to determine an interface associated with the source address of the broadcast packet and if no interface exists in the data structure, write the interface mapping between the consumer processing device and the interface on which the request is received to a data structure.

20. The apparatus of claim 19 wherein the one or more processors execute instructions to match, prior to said read, the dynamic level two address to the data stored in the memory storage.
